(19) United States
(12) Patent Application Publication
(10) Pub. No.: US 2024/0274897 A1
(43) Pub. Date: Aug. 15, 2024

(54) A BMS SLAVE BOARD, A BMS MASTER BOARD, A BATTERY PACK AND A METHOD FOR CONTROLLING A TEMPERATURE AND HUMIDITY THEREIN

(71) Applicant: Jing-Jin Electric Technologies Co., Ltd., Beijing (CN)

(72) Inventor: Zhenya HAN, Beijing (CN)

(21) Appl. No.: 18/702,444

(22) PCT Filed: Jun. 14, 2023
(86) PCT No.: PCT/CN2023/100095

§ 371 Date: Apr. 18, 2024

(30) Foreign Application Priority Data
Sep. 16, 2022 (CN) 202211129673.8

(51) Int. Cl. H01M 10/42; H01M 10/615; H01M 10/6554; H01M 50/24; H01M 50/249

(52) U.S. Cl. CPC H01M 10/425; H01M 10/4285; H01M 10/615; H01M 10/6554; H01M 50/24; H01M 2010/4271; H01M 2010/4278; H01M 50/249

(57) ABSTRACT

A BMS slave board, a BMS master board, a battery pack and a method for controlling a temperature and humidity therein are disclosed. The BMS slave board comprises: a first temperature and humidity sensing unit for collecting and storing a temperature and humidity of a predetermined area within a battery pack housing; and a battery sampling chip communicatively coupled with the first temperature and humidity sensing unit and used to acquire the temperature and humidity by accessing the first temperature and humidity sensing unit, wherein the first temperature and humidity sensing unit and the battery sampling chip are installed on a same circuit board, and a power input end of the first temperature and humidity sensing unit is connected to a power output end of a battery module. In the embodiment of the present disclosure, the power input end of the first temperature and humidity sensing unit is connected to the power output end of the battery module, so that the temperature and humidity can be continuously monitored without being affected by the factor of entire vehicle stopping and powering down, thereby solving the problem in the prior art that the humidity inside the battery pack cannot be monitored after the entire vehicle is powered down.

### CROSS REFERENCING OF RELATED APPLICATIONS

The present application claims priority from the Chinese patent application No. 202211129673.8 filed with the Chinese Patent Office on Sep. 16, 2022 and entitled “A BMS SLAVE BOARD, A BMS MASTER BOARD, A BATTERY PACK AND A METHOD FOR CONTROLLING A TEMPERATURE AND HUMIDITY THEREIN”, the content of which is hereby incorporated by reference in its entirety.

### TECHNICAL FIELD

The present disclosure relates to the technical field of electric vehicle batteries, in particular to a BMS slave board, a BMS master board, a battery pack and a method for controlling a temperature and humidity therein.

### BACKGROUND

As a core component of electric vehicles, power batteries provide electrical energy for the driving motors of electric vehicles.

The on-board power battery is usually of a sealed design of an IP67 rating, and a balancing valve is provided to cope with changes in air pressure inside and outside the battery pack to ensure a balance of air pressure inside and outside. Therefore, although the outer housing of the battery pack can prevent the invasion of external liquid water, it cannot prevent water vapor from entering the battery pack. When the water vapor inside the battery pack accumulates to a certain extent, the condensation will very likely occur when temperature changes, leading to electrical insulation failure and even safety issues. Therefore, humidity monitoring and condensation prevention inside the battery pack have always been an important part of electrical safety design. Referring to FIG. 1, the prevailing solution is to install an independent humidity monitoring module 5 inside the battery pack.

In the process of implementing the present disclosure, the inventor discovered at least the following problems in the prior art: this humidity monitoring module usually needs to be equipped with an independent low-voltage battery to supply power and connected to the vehicle controller through CAN communication to achieve the purpose of monitoring. Due to power supply of the low-voltage battery, this module cannot achieve the function of monitoring when the entire vehicle is stopped and powered down. Moreover, if humidity exceeds the threshold, only an alarm signal can be issued to wait for processing, which cannot solve the problem of humidity inside the battery pack.

### SUMMARY

With respect to the above problems, the present disclosure provides a BMS slave board, a BMS master board, a battery pack, and a method for controlling a temperature and humidity therein, in order to solve the problems in the prior art that the humidity inside the battery pack cannot be monitored after the entire vehicle is powered down and that if humidity exceeds the threshold, only an alarm signal is issued and the condensation cannot be removed.

In order to achieve the above object, the present disclosure adopts the following technical solutions.

A first aspect of the present disclosure provides a BMS slave board, comprising:

a first temperature and humidity sensing unit for collecting and storing a temperature and humidity of a predetermined area within a battery pack housing; and

a battery sampling chip communicatively coupled with the first temperature and humidity sensing unit and is used to acquire the temperature and humidity by accessing the first temperature and humidity sensing unit:

wherein the first temperature and humidity sensing unit and the battery sampling chip are installed on a same circuit board, and a power input end of the first temperature and humidity sensing unit is connected to a power output end of a battery module.

In the BMS slave board of the embodiment of the present disclosure, the first temperature and humidity sensing unit and the battery sampling chip are provided on the same circuit board, thereby reducing the space occupied by the independent humidity monitoring module in the battery pack in the prior art, and in the embodiment of the present disclosure, the power input end of the first temperature and humidity sensing unit is connected to the power output end of the battery module, so that the temperature and humidity can be continuously monitored without being affected by the factor of entire vehicle stopping and powering down.

According to an embodiment of the present disclosure, the first temperature and humidity sensing unit is a temperature and humidity sensor, the temperature and humidity sensor comprises:

a humidity probe:

a temperature probe:

an analog-to-digital converter for performing analog-to-digital conversion on signals collected by the humidity probe and the temperature probe:

a logic control memory for acquiring and storing data from the analog-to-digital conversion; and an I2C interface for transmitting the data in the logic control memory to the battery sampling chip.

According to an embodiment of the present disclosure, the power output end of the battery module is connected to the power input end of the first temperature and humidity sensing unit after voltage regulated through a linear voltage regulator or a DC to DC converter.

A second aspect of the present disclosure provides a BMS master board, the BMS master board is arranged inside the battery pack housing and is used to connect with the BMS slave board as described in the first aspect, and determines whether there is condensation in the battery pack now based on an enthalpy-humidity diagram and historical temperature and humidity data obtained from the first temperature and humidity sensing unit, or determines whether there is condensation in the battery pack now by comparing a current humidity value in the battery pack with a preset humidity value.

The BMS master board of the embodiment of the present disclosure determines whether condensation occurs inside the battery pack based on the recorded temperature and humidity data in the battery pack, combined with the enthalpy-humidity diagram. Compared with the prior art that only the temperature and humidity are measured and displayed, it is more accurately determined whether condensation occurs inside the battery pack.

According to an embodiment of the present disclosure, the BMS master board further comprises a second temperature and humidity sensing unit for collecting and storing a temperature and humidity of a predetermined area within the battery pack housing, and the BMS master board is further used to compare a current humidity value measured by the second temperature and humidity sensing unit in the battery pack with a preset humidity value, and determine whether there is condensation in the battery pack now:

According to an embodiment of the present disclosure, the BMS master board further comprises an RTC unit for waking up the BMS and inspecting the battery pack within a predetermined time.

According to an embodiment of the present disclosure, the BMS master board further includes a high and low side output unit for providing power to a load in a high and/or low side manner.

A third aspect of the present disclosure provides a battery pack comprising: the BMS slave board as described in the first aspect, the BMS master board as described in the second aspect, and a dehumidification module for dehumidifying under the control of the BMS master board.

According to an embodiment of the present disclosure, the dehumidification module is an electric dehumidification module, a power input end of the electric dehumidification module is connected to the BMS master board, the electric dehumidification module comprises a breathable protective casing, an electrolytic electrode, and a proton exchange membrane, the electrolytic electrode and proton exchange membrane are installed inside the breathable protective casing, the breathable protective casing is embedded in an opening on the battery pack housing, the electrolytic electrode is used to adsorb and electrolyze water molecules inside the battery pack into oxygen and protons, and the proton exchange membrane is used to discharge the protons from the battery pack to make the protons and external oxygen regenerate water molecules for dehumidification.

According to an embodiment of the present disclosure, the dehumidification module is a moisture absorption module, a power input end of the moisture absorption module is connected to the BMS master board, the moisture absorption module comprises a moisture absorption material pack, a heating plate, and a temperature sensor, the moisture absorption material package is used to adsorb water molecules inside the battery pack, the heating plate is used to heat the moisture absorption material package to restore a moisture absorption material of the moisture absorption material package, and the temperature sensor is used to monitor a heating temperature of the heating plate.

A fourth aspect of the present disclosure provides a method for controlling a temperature and humidity in a battery pack, comprising:

using a temperature and humidity sensor to acquire a temperature and humidity of a predetermined area of a battery pack housing, wherein the temperature and humidity sensor is installed on a BMS slave board, and a power input end of the temperature and humidity sensor is connected to a power output end of a battery module:

judging whether there is condensation inside the battery pack based on the temperature and humidity through an enthalpy-humidity diagram; and

when a result of judgment is yes, activating a dehumidification module to dehumidify the battery pack.

### BRIEF DESCRIPTION OF DRAWINGS

By reading the detailed description of the preferred embodiments below; various other advantages and benefits will become clear to a person of ordinary skill in the art. The accompanying drawings are only used for the purpose of illustrating the preferred embodiments, and should not be considered as a limitation to the present disclosure. Moreover, throughout the drawings, the same reference numerals are used to denote the same components. In the drawings:

FIG. 1 is a schematic diagram of the structure of a battery pack in the prior art;

FIG. 2 is a schematic diagram of the structure of a battery pack according to an embodiment of the present disclosure:

FIG. 3 is a flowchart of a method for controlling a temperature and humidity in a battery pack according to an embodiment of the present disclosure:

FIG. 4 is a flowchart of a method for controlling a temperature and humidity in a battery pack according to an embodiment of the present disclosure:

FIG. 5 is a schematic diagram of an electric dehumidification module of the battery pack according to an embodiment of the present disclosure:

FIG. 6 is an enthalpy-humidity diagram of air:

FIG. 7 is a schematic diagram for determining whether condensation occurs inside the battery pack based on FIG. 6:

FIG. 8 is a schematic diagram of the structure of a battery pack according to an embodiment of the present disclosure; and

FIG. 9 is a flowchart of a method for controlling a temperature and humidity in a battery pack according to an embodiment of the present disclosure.

In the drawings: 5—humidity monitoring module, 101—entire vehicle ignition switch: 102—entire vehicle CAN end: 103—entire vehicle low voltage power supply: 201—first BMS slave board: 202—temperature and humidity sensor: 203—battery sampling chip: 204-12C interface: 205—chip power supply end: 206—humidity probe: 207—temperature probe: 208 analog to digital converter: 209—logic control memory: 210—first communication end: 212—second BMS slave board: 301—battery pack housing: 302—BMS master board: 303—second battery module: 304—first battery module: 305—balancing breathable valve: 306—maintenance window: 307—master board CAN end: 308—key signal end: 309—low voltage power supply end: 310—second communication end: 311—high and low side output unit: 312—temperature monitoring port: 401—electric dehumidification module: 402—power supply module: 403—electrolytic electrode: 404 proton exchange membrane: 405—breathable protective casing: 406—water molecules: 407—hydrogen ion: 408—oxygen: 411—moisture absorption module: 412—moisture absorbing material package: 413—heating plate: 414—temperature sensor.

### DETAILED DESCRIPTION

In order to make the object, technical solutions, and advantages of the present disclosure clearer, the present disclosure will be described clearly and completely in conjunction with the specific embodiments and corresponding drawings. Obviously, the embodiments described are only part of rather than all of the embodiments of the present disclosure. Based on the embodiments in the present disclosure, all other embodiments obtained by those of ordinary skill in the art without paying creative work shall fall within the protection scope of the present disclosure.

It should be understood that the terms “comprise/include”, “consist of” or any other variants are intended to cover non-exclusive inclusion, so that the product, apparatus, process or method including a series of elements may not only include those elements, but may also include other elements not stated explicitly, or elements inherent to the product, apparatus, process or method. Without more limitations, an element defined by the phrase “comprise/include” or “consist of” does not exclude the case that there are other same elements in the product, apparatus, process or method including the element.

It should also be understood that, orientation or positional relationship indicated by the terms “upper”, “lower”, “front”, “rear”, “left”, “right”, “top”, “bottom”, “inside”, “outside”, etc. are orientation or positional relationship based on the drawings, which are merely for convenience of describing the present disclosure and simplifying the description, rather than indicating or implying that the device, component or structure referred to must have a specific orientation, or must be constructed and operated with a specific orientation, they should not be construed as limiting the present disclosure.

In the present disclosure (this embodiment), the right is the front and the left is the back.

In the present disclosure, unless otherwise expressly specified and defined, the terms “installed”, “connected”, “fixed” and the like should be understood in a broad sense, for example, it may be fixedly connected, or removably connected, or integrally connected: it may also be mechanically connected or electrically connected: it may also be directly connected or indirectly connected through a middleware: it may also be internally communicated or interacted between two components. For a person of ordinary skill in the art, the specific meaning of these terms in the present disclosure should be understood according to specific situations.

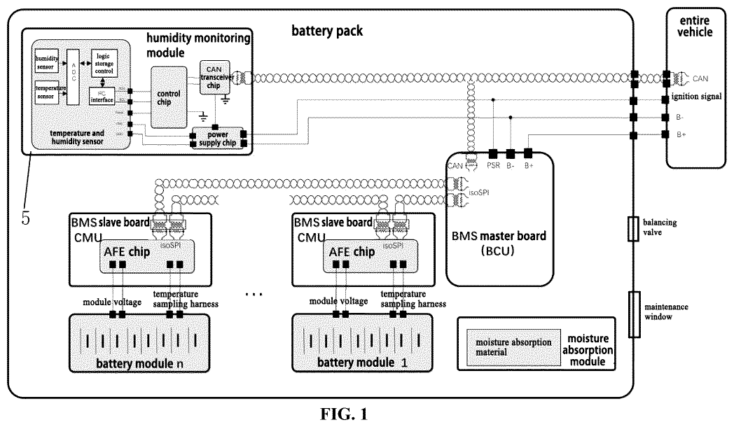

New energy vehicles are equipped with low-voltage battery and high-voltage battery packs. The high-voltage battery pack contains several battery modules. The BMS (Battery Management System) is used to manage batteries so that they can maintain a better state and work stably. As shown in FIG. 1, the distributed BMS comprises one BMS master board and several BMS slave boards in hardware. The BMS slave boards are distributed in the battery pack. The humidity monitoring module of the conventional BMS operates at a low voltage from the low-voltage battery of the entire vehicle. Therefore, when the vehicle is stopped and powered down, the humidity monitoring module cannot be powered up, and the humidity inside the battery pack cannot continue to be monitored. To solve or partially solve the technical problem in the prior art that the humidity in the battery pack cannot be monitored after the vehicle is powered off, an embodiment of the present disclosure provides a solution, a specific implementation of which will be described below:

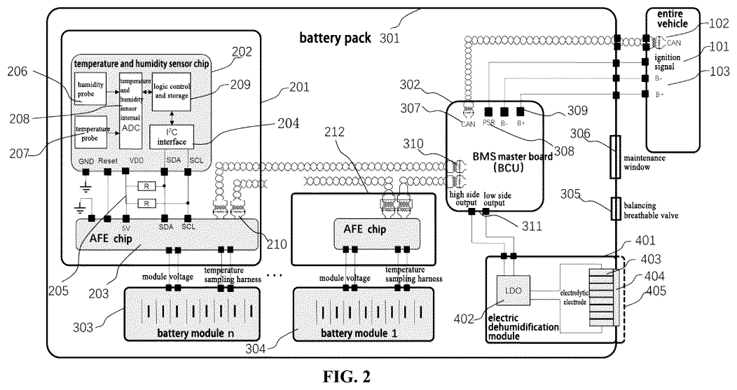

Referring to FIG. 2, a first aspect of the embodiment of the present disclosure provides a BMS slave board, which is the first BMS slave board 201 in FIG. 2. The first BMS slave board 201 comprises a first temperature and humidity sensing unit and a battery sampling chip 203. The battery sampling chip is also known as the AFE (Analog Front End) chip.

The first temperature and humidity sensing unit is used to collect and store the temperature and humidity of a predetermined area within the battery pack housing 301. The predetermined area can be set according to actual needs.

The battery sampling chip 203 is communicatively coupled with the first temperature and humidity sensing unit and is used to acquire the temperature and humidity by accessing the first temperature and humidity sensing unit. The first temperature and humidity sensing unit and the battery sampling chip 203 are installed on the same circuit board, and the power input end of the first temperature and humidity sensing unit is connected to the power output end of the battery module. In an embodiment, the power output end of the battery module is connected to the power input end of the first temperature and humidity sensing unit after voltage regulated through a linear voltage regulator (low dropout regulator. LDO). The advantage of a linear voltage regulator is that it can still maintain a stable voltage output when the input voltage or load current changes. In an embodiment, the linear voltage regulator is integrated on the battery sampling chip 203. The battery sampling chip 203 takes power from the battery module and makes voltage regulation, then supplies power to the first temperature and humidity sensing unit, which can further reduce the occupied space. In an embodiment, the power output end of the battery module is connected to the power input end of the first temperature and humidity sensing unit after voltage regulation through a DC to DC converter (DCDC). The advantages of a DC to DC converter are low power consumption, high efficiency, high power, support for multiple voltage transformations, and isolation of input and output.

In the BMS slave board of the embodiment of the present disclosure, the first temperature and humidity sensing unit and the battery sampling chip are provided on the same circuit board, thereby reducing the space occupied by the independent humidity monitoring module in the battery pack in the prior art. In the embodiment of the present disclosure, the power input end of the first temperature and humidity sensing unit is connected to the power output end of the battery module, so that the temperature and humidity can be continuously monitored without being affected by the factor of entire vehicle stopping and powering down.

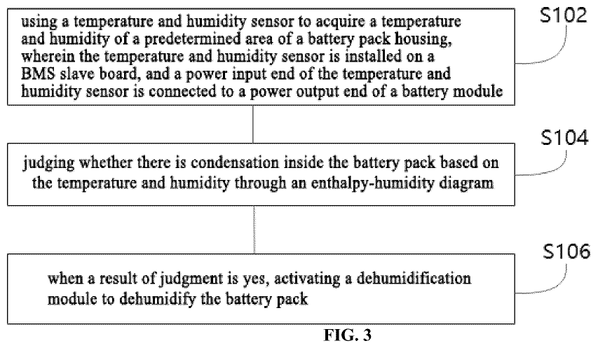

In an example, referring to FIG. 3, the first temperature and humidity sensing unit of the BMS slave board is a temperature and humidity sensor 202. The temperature and humidity sensor 202 comprises an I2C interface 204, a humidity probe 206, a temperature probe 207, an analog-to-digital converter 208, and a logic control memory 209. The humidity probe 206 monitors the humidity changes of the battery pack, the temperature probe 207 monitors the temperature changes of the battery pack, the analog-to-digital converter 208 is used to perform analog-to-digital conversion on the signals collected by the humidity probe 206 and the temperature probe 207, the logic control memory 209 is used to acquire and store the data after analog-to-digital converted, and the I2C interface 204 is used to transmit the data in the logic control memory 209 to the battery sampling chip 203. The BMS slave board can be selectively equipped with temperature and humidity sensors at specific locations within the battery pack, and humidity sensors are installed only in areas that require monitoring to save costs.

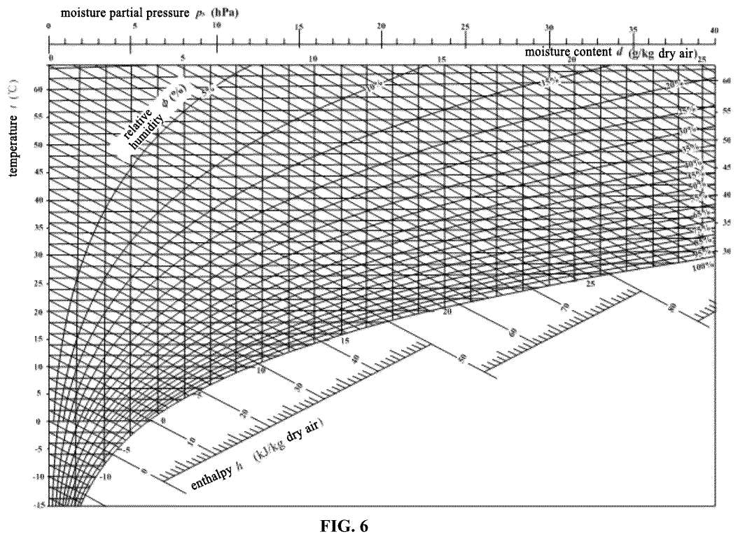

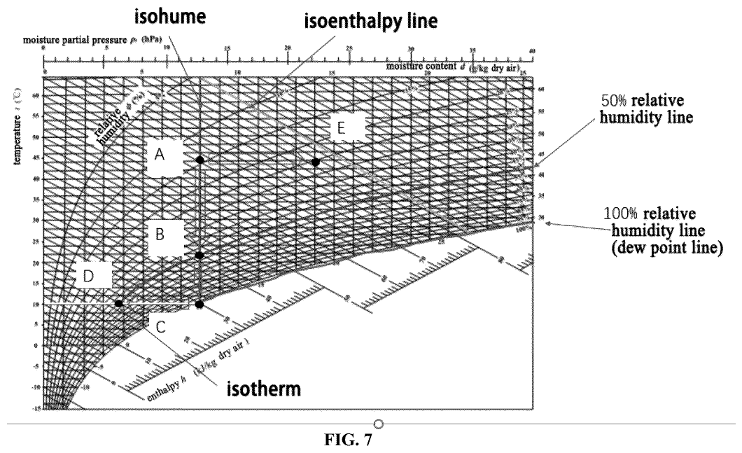

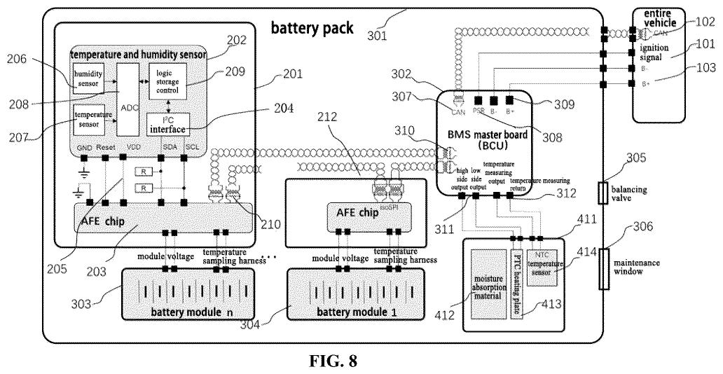

A second aspect of the embodiment of the present disclosure provides a BMS master board, as shown in FIGS. 2 and 8. The BMS master board 302 is arranged inside the battery pack housing 301 and is used to connect with the BMS slave board of the first aspect, and determines whether there is condensation in the battery pack now based on an enthalpy-humidity diagram and historical temperature and humidity data obtained from the first temperature and humidity sensing unit. Referring to FIG. 6, an enthalpy-humidity diagram is a graphical representation of the relationship between various parameters of moist air, which can reflect the thermophysical properties of moist air and various air treatment processes. It can be understood that the enthalpy-humidity diagram data sheet is recorded in the memory of the BMS master board and can be called by the BMS master board. Referring to FIG. 7, the enthalpy-humidity diagram includes isotherms, isohumes (water content), and relative isohumes. The 100% relative isohume is also the dew point temperature line, which means condensation begins when reaching this line or below: Assuming that the initial state of the air inside the battery pack is at point A (temperature 43° C., relative humidity 15%), when the temperature of the battery pack decreases and the humidity remains unchanged (the total amount of water in the air inside the battery pack remains unchanged), the air state inside the battery pack will reach point B (temperature 22° C., relative humidity 50%) along the relative isohume. If the temperature continues to decrease to point C (temperature 10° C. relative humidity 100%), condensation will begin to occur. That is to say, under a certain atmospheric pressure condition, the temperature and humidity data measured can determine the position in the enthalpy-humidity diagram. If the position is located on the dew point line or beyond the area enclosed by the dew point line and the coordinate axis, it is determined that there is condensation inside the battery pack.

In an embodiment, the BMS master board 302 is used to compare the current humidity value in the battery pack with a preset humidity value to judge whether there is condensation in the battery pack now: The preset humidity value is set based on experience. If the humidity value inside the battery pack is greater than the preset humidity value, it is determined that there is condensation inside the battery pack, otherwise there is no condensation.

The BMS master board of the embodiment of the present disclosure determines whether condensation occurs in the battery pack based on the temperature and humidity data recorded in the battery pack, combined with the enthalpy-humidity diagram. Compared with the prior art in which only temperature and humidity are measured and displayed, it is more accurate to determine condensation in the battery pack.

In an example, the BMS master board further comprises a second temperature and humidity sensing unit, which is used to collect and store the temperature and humidity of a predetermined area within the battery pack housing 301. The BMS master board 302 is also used to compare the current humidity value inside the battery pack measured by the second temperature and humidity sensing unit with a preset humidity value to determine whether there is condensation inside the battery pack now:

In an example, the BMS master board further comprises an RTC (Real Time Clock) unit, which is used to wake up the BMS and inspect the battery pack within a predetermined time. The predetermined time is set according to actual needs, and optionally, it is 3 hours. The RTC unit may be a separate chip. It can be understood as setting an alarm clock for the BMS to wake up at a set time interval, such as every 3 hours. The RTC unit can prevent the BMS from working continuously with power on, thereby achieving the goal of power saving.

In an example, the BMS master board further comprises a high and low side output unit 311, which is used to provide power to a load in a high and/or low side manner. The high and low side output unit 311 comprises a high side output end and a low side output end. High side drive refers to enabling a driving device by directly closing the switch on the power supply line before the appliance or driving device, while low side drive is enabling a driving device by closing the ground wire after the appliance or driving device.

A third aspect of the embodiment of the present disclosure provides a battery pack. Referring to FIGS. 2 and 8, the battery pack comprises the BMS slave board in the first aspect, the BMS master board in the second aspect, and a dehumidification module. The dehumidification module is used for dehumidification under the control of the BMS master board. When the master board determines that there is condensation inside the battery pack, the dehumidification module can be activated, regardless of whether the entire vehicle is in a startup or shutdown state. The dehumidification module is an independent module that can be adjusted in position and quantity as needed. In an embodiment, the battery pack comprises a balancing breathable valve 305 and a maintenance window 306. The balancing breathable valve 305 is used to prevent internal gas pressure changes caused by an increase or decrease in the temperature of the battery pack, thereby damaging the structure of the battery pack. The maintenance window 306 is a sealed maintenance cover that can only be opened when needed.

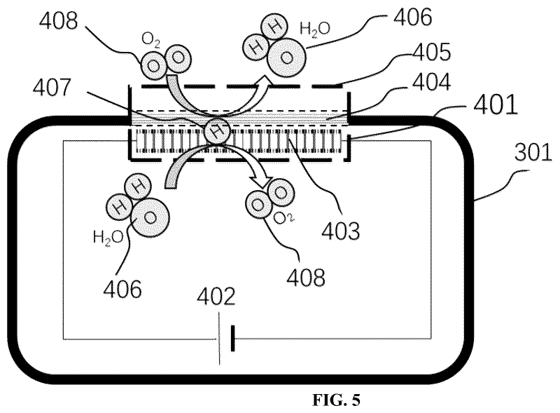

In an example, referring to FIGS. 2 and 5, the dehumidification module is an electric dehumidification module 401. The power input end of the electric dehumidification module 401 is connected to the BMS master board 302. The electric dehumidification module 401 comprises a breathable protective casing 405, an electrolytic electrode 403, and a proton exchange membrane 404. The electrolytic electrode 403 and the proton exchange membrane 404 are installed inside the breathable protective casing 405, and the breathable protective casing 405 is embedded in an opening on the battery pack housing 301. The electrolytic electrode 403 is used to adsorb and electrolyze water molecules inside the battery pack into oxygen and protons, and the proton exchange membrane 404 is used to discharge protons from the battery pack to make the protons and external oxygen regenerate water molecules for dehumidification.

In an example, referring to FIG. 8, the dehumidification module is a moisture absorption module 411. The power input end of the moisture absorption module 411 is connected to the BMS master board 302. The moisture absorption module 411 comprises a moisture absorption material package 412, a heating plate 413, and a temperature sensor 414. The moisture absorption material package 412 is used to adsorb water molecules inside the battery pack, the heating plate 413 is used to heat the moisture absorption material package 412 to restore the moisture absorption material, and the temperature sensor 414 is used to monitor a heating temperature of the heating plate 413. Optionally, the heating element is a PTC (Positive Temperature Coefficient) ceramic heating element. In the prior art, the moisture absorption material package installed inside the battery pack can absorb water vapor from the air at the initial stage to ensure dryness in the battery pack. However, when the moisture absorption material is saturated, it will lose its humidity control function, so it can only delay but cannot completely solve the humidity problem inside the battery pack. In this example, heating by the heating plate can restore the moisture absorption material, thereby completely removing condensation.

A fourth aspect of the embodiment of the present disclosure provides a method for controlling a temperature and humidity in a battery pack. Referring to FIG. 3, the implementation process of the method is as follows:

Step S102, using a temperature and humidity sensor to acquire a temperature and humidity of a predetermined area of a battery pack housing 301, wherein the temperature and humidity sensor is installed on a BMS slave board, and a power input end of the temperature and humidity sensor is connected to a power output end of a battery module:

In this embodiment, the number of temperature and humidity sensors may be one or more, preferably one. There is a voltage regulating device between the temperature and humidity sensor and the battery module.

Step S104, judging whether there is condensation inside the battery pack housing 301 based on the temperature and humidity through an enthalpy-humidity diagram; and

In this embodiment, the enthalpy-humidity diagram data sheet is recorded in a memory, and the data sheet can be retrieved from the memory, and it can be determined whether condensation occurs in the battery pack housing according to the given temperature and humidity.

Step S106, when a result of judgment is yes, activating a dehumidification module to dehumidify the battery pack.

In this embodiment, the dehumidification module may be an electric dehumidification module 401 or a moisture absorption module 411. The dehumidification module may be activated manually or under control of the BMS master board.

Below are two examples to illustrate the content involved in the above embodiments.

### First Example

As shown in FIG. 2, a battery pack according to the first example of the present disclosure comprises a first BMS slave board 201 having a temperature and humidity sensor 202, a BMS master board 302, and an electric dehumidification module 401. Compared with a conventional second BMS slave board 212, the first BMS slave board 201 has the temperature and humidity sensor 202 integrated therein. During operation, a battery sampling chip 203 takes power from a second battery module 303 and supplies power to the temperature and humidity sensor 202 through a chip power supply end 205. A first battery module 304 supplies power to the second BMS slave board. The BMS master board 302 has a master board CAN end 307, which is connected to the entire vehicle CAN end 102. The first BMS slave board 201 has a first communication end 210, the BMS master board 302 has a second communication end 310, and there is a communication line between the first communication end 210) and the second communication end 310. The BMS master board 302 has a low-voltage power input end 309, which is connected to the entire vehicle low-voltage power supply.

A humidity probe 206 and a temperature probe 207 are integrated in the temperature and humidity sensor 202. The logic control memory 209 acquires and caches data from the temperature and humidity probes through a built-in analog-to-digital converter 208, then, through the I2C interface 204 transmits it to the battery sampling chip 203. After internal processing, the battery sampling chip 203 transmits the voltage of the second battery module 303 and the temperature and humidity data to the BMS master board 302 through the first communication end 210 via an internal communication harness.

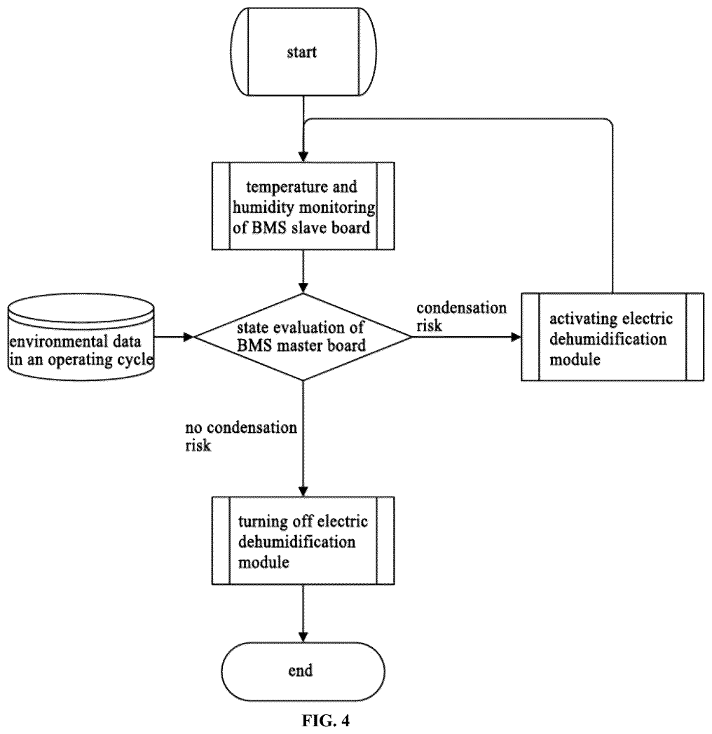

Referring to FIGS. 2 and 4, the BMS master board 302 may determine whether the air humidity inside the battery will increase beyond the dew point (100% humidity) due to temperature changes during the working cycle based on the recording of the battery pack in the working cycle and the enthalpy-humidity diagram, and based on the result of determination, the electric dehumidification module 401 may be activated for dehumidification.

Referring to FIGS. 2 and 5, when the electric dehumidification module 401 works, the BMS master board 302 supplies power to the electric dehumidification module 401 through the high and low side output unit 311. The electric dehumidification module 401 may be equipped with a built-in power supply module 402 to maintain a constant voltage on the electrolytic electrode 403. Water molecules 406 in the air inside the battery pack are adsorbed onto the electrolytic electrode 403 and electrolyzed into hydrogen ions 407 and oxygen 408 through catalysis. The hydrogen ions 407 are transferred to the outside of the battery pack through the proton exchange membrane 404, and react with oxygen 408 in the external air to generate water molecule 406, thereby reducing the air humidity inside the battery pack.

When the entire vehicle is powered up and works, the entire vehicle ignition switch 101 is closed, and the power is supplied to the BMS master board 302 via a key signal end 308. When the entire vehicle is powered down, the entire vehicle ignition switch 101 is opened, and the BMS sleeps, but it can be awakened timely by a built-in RTC unit and powered by an entire vehicle low-voltage power supply 103 to support the BMS system monitoring and dehumidification system operation.

In this embodiment, the first BMS slave board 201 having the temperature and humidity sensor 202 may be arranged according to the distribution requirements of humidity monitoring inside the battery pack, and the second BMS slave board 212 without a humidity sensor can be used in other positions. The modular design facilitates flexible arrangement. The electric dehumidification module 401 is an independent module that can be adjusted in position and quantity as needed.

### Second Example

The second example of the present disclosure is a variant of the first example. The second example of the present disclosure has the same humidity monitoring function as the first example. but differs from the first example in that, as shown in FIG. 8, the electric dehumidification module 401 in the first example has been replaced with a moisture absorption module 411. The moisture absorption module 411 is equipped with a moisture absorption material package 412, a heating plate 413, and a temperature sensor 414. The BMS master board 302 has a temperature monitoring port 312, which is connected to the temperature sensor 414. After the temperature sensor 414 is assembled in the battery pack, the moisture absorption material package 412 begins to absorb the moisture in the air inside the battery pack, thereby ensuring that the humidity inside the battery pack is within a reasonable range.

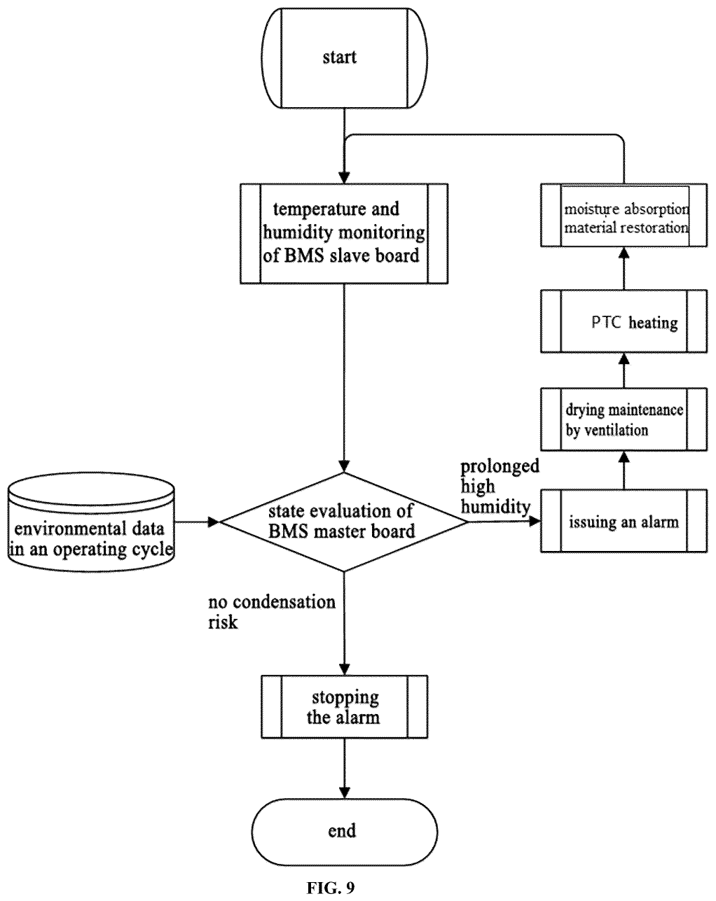

Referring to FIGS. 8 and 9, when the moisture absorption material tends to be saturated, the average level of humidity inside the battery pack will gradually increase. At this point, the BMS master board 302 recognizes a risk that the trend of humidity change will cause condensation, and sends a warning signal through the vehicle CAN end 102 to introduce manual maintenance. During manual maintenance, dry air is introduced through the maintenance window 306 to replace the high humidity air inside the battery pack. At the same time, the BMS master board 302 can supply power to the heating plate 413 through the high and low side output unit 311. By heating, the moisture absorption material package 412 removes the absorbed moisture and achieves the restoration of the moisture absorption function. At the same time, the BMS master board 302 monitors the temperature of the heating plate 413 through the temperature sensor 414 to prevent overheating.

The above only describes the embodiments of the present disclosure, and is not intended to limit the scope of protection of the present disclosure. Any modification, equivalent substitution, improvement, expansion, etc. made in the spirit and principle of the present disclosure shall all fall within the protection scope of the present disclosure.

1. A BMS slave board, comprising:
a first temperature and humidity sensing unit for collecting and storing a temperature and humidity of a predetermined area within a battery pack housing; and
a battery sampling chip communicatively coupled with the first temperature and humidity sensing unit and is used to acquire the temperature and humidity by accessing the first temperature and humidity sensing unit;
wherein the first temperature and humidity sensing unit and the battery sampling chip are installed on a same circuit board, and a power input end of the first temperature and humidity sensing unit is connected to a power output end of a battery module.

2. The BMS slave board according to claim 1, wherein the first temperature and humidity sensing unit is a temperature and humidity sensor, the temperature and humidity sensor comprises:
a humidity probe;
a temperature probe;
an analog-to-digital converter for performing analog-to-digital conversion on signals collected by the humidity probe and the temperature probe;
a logic control memory for acquiring and storing data from the analog-to-digital conversion; and
an I2C interface for transmitting the data in the logic control memory to the battery sampling chip.

3. The BMS slave board according to claim 1, wherein the power output end of the battery module is connected to the power input end of the first temperature and humidity sensing unit after voltage regulated through a linear voltage regulator or a DC to DC converter.

4. A BMS master board, wherein the BMS master board is arranged inside the battery pack housing and is used to connect with the BMS slave board according to claim 1, and determines whether there is condensation in the battery pack now based on an enthalpy-humidity diagram and historical temperature and humidity data obtained from the first temperature and humidity sensing unit, or determines whether there is condensation in the battery pack now by comparing a humidity value in the battery pack with a preset humidity value.

5. The BMS master board according to claim 4, wherein it further comprises a second temperature and humidity sensing unit for collecting and storing a temperature and humidity of a predetermined area within the battery pack housing, and the BMS master board is further used to compare a current humidity value measured by the second temperature and humidity sensing unit in the battery pack with a preset humidity value, and determine whether there is condensation in the battery pack now.

6. The BMS master board according to claim 4, wherein it further comprises an RTC unit for waking up the BMS and inspect the battery pack within a predetermined time.

7. The BMS master board according to claim 4, wherein it further includes a high and low side output unit for providing power to a load in a high and/or low side manner.

8. A battery pack, comprising the BMS slave board according to claim 1, the BMS master board according to claim 4, and a dehumidification module for dehumidification under the control of the BMS master board.

9. The battery pack according to claim 8, wherein the dehumidification module is an electric dehumidification module, a power input end of the electric dehumidification module is connected to the BMS master board, the electric dehumidification module comprises a breathable protective casing, an electrolytic electrode, and a proton exchange membrane, the electrolytic electrode and proton exchange membrane are installed inside the breathable protective casing, the breathable protective casing is embedded in an opening on the battery pack housing, the electrolytic electrode is used to adsorb and electrolyze water molecules inside the battery pack into oxygen and protons, and the proton exchange membrane is used to discharge protons from the battery pack to make protons and external oxygen regenerate water molecules for dehumidification.

10. The battery pack according to claim 8, wherein the dehumidification module is a moisture absorption module, a power input end of the moisture absorption module is connected to the BMS master board, the moisture absorption module comprises a moisture absorption material package, a heating plate, and a temperature sensor, the moisture absorption material package is used to adsorb water molecules inside the battery pack, the heating plate is used to heat the moisture absorption material package to restore a moisture absorption material of the moisture absorption material package, and the temperature sensor is used to monitor a heating temperature of the heating plate.

11. A BMS master board, wherein the BMS master board is arranged inside the battery pack housing and is used to connect with the BMS slave board according to claim 2, and determines whether there is condensation in the battery pack now based on an enthalpy-humidity diagram and historical temperature and humidity data obtained from the first temperature and humidity sensing unit, or determines whether there is condensation in the battery pack now by comparing a humidity value in the battery pack with a preset humidity value.

12. A BMS master board, wherein the BMS master board is arranged inside the battery pack housing and is used to connect with the BMS slave board according to claim 3, and determines whether there is condensation in the battery pack now based on an enthalpy-humidity diagram and historical temperature and humidity data obtained from the first temperature and humidity sensing unit, or determines whether there is condensation in the battery pack now by comparing a humidity value in the battery pack with a preset humidity value.

13. A battery pack, comprising the BMS slave board according to claim 1, the BMS master board according to claim 5, and a dehumidification module for dehumidification under the control of the BMS master board.

14. A battery pack, comprising the BMS slave board according to claim 1, the BMS master board according to claim 6, and a dehumidification module for dehumidification under the control of the BMS master board.

15. A battery pack, comprising the BMS slave board according to claim 1, the BMS master board according to claim 7, and a dehumidification module for dehumidification under the control of the BMS master board.

16. A battery pack, comprising the BMS slave board according to claim 2, the BMS master board according to claim 4, and a dehumidification module for dehumidification under the control of the BMS master board.

17. A battery pack, comprising the BMS slave board according to claim 3, the BMS master board according to claim 4, and a dehumidification module for dehumidification under the control of the BMS master board.

18. A battery pack, comprising the BMS slave board according to claim 2, the BMS master board according to claim 5, and a dehumidification module for dehumidification under the control of the BMS master board.

19. A battery pack, comprising the BMS slave board according to claim 3, the BMS master board according to claim 5, and a dehumidification module for dehumidification under the control of the BMS master board.

20. A battery pack, comprising the BMS slave board according to claim 2, the BMS master board according to claim 6, and a dehumidification module for dehumidification under the control of the BMS master board.
